(19) United States
(12) Patent Application Publication
(10) Pub. No.: US 2006/0164681 A1
(43) Pub. Date: Jul. 27, 2006

(54) Image processing apparatus

(75) Inventor: Yoshiaki Utsubo, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Oki Data Corporation

(21) Appl. No.: 11/336,550

(22) Filed: Jan. 20, 2006

(30) Foreign Application Priority Data
Jan. 24, 2005 (JP) 2005-015585

(51) Int. Cl. G06F 3/12

(52) U.S. Cl. 358/1.15

(57) ABSTRACT

An image processing apparatus of the present invention includes an output device information that selects an output device for outputting the image information and a limited information for limiting an output of the image information and includes an output allowance determination section for comparing the output device information with the limited information to determine the output to be allowed or not allowed by the image forming apparatuses as the output devices. Accordingly, no setting is required for the plurality of image forming apparatuses as the output devices for outputting the image information since the image processing apparatus can determines whether or not the printing apparatus can output. This allows an administrator for easy setting operation.

### BACKGROUND OF THE INVENTION

1. Field of the Invention

The present invention relates to an image processing apparatus for outputting image data to printers.

2. Description of Related Art

Recently, computer environment has been developed to have plural computers interconnected through network. According to this tendency, plural printers are also connected to the network. In this regard, each computer is allowed to use plural printers.

Under the circumstances, users have a demand such as to limit computers usable with each printer. To allow a specified printer to output data to be printed, an art has been known in which a user's identification code is registered at the specified printer for each user capable of using the specified printer, which identification information corresponding to the user's identification code registered in the specified printer is sent from the computer to the printer in association with printing data, and which the printer can carry out printing only where the user's identification code corresponds to the identification information. (See, for example, Japanese Patent Laid-Open No. 2002-91735).

In the above Japanese Patent Laying Open No. 2002-91735, it is required that an identification code is assigned to each printer as well as identification information is set to each computer. Therefore, an administrator has to do complicated setting operation, and management may become cumbersome.

The present invention, in consideration with the above situation, attempts to provide an image processing apparatus capable of determining whether or not an output of the image information is allowed by an image forming apparatus without requiring any setting of the image forming apparatus.

### SUMMARY OF THE INVENTION

The image processing apparatus according to the present invention connected to a plurality of image forming apparatuses as output devices of image information and outputting the image information to any selected one of the plurality of image forming apparatuses has an output device selecting section for selecting any one of the plurality of output devices, an output section for outputting the image information to the output device thus selected by the output device selecting section, a limited information storing section for storing limited information which limits an output of the image information in accordance with each of the plurality of the output devices and an output allowance determination section for determining whether or not the output of the image information is allowed to the selected output device based on output information regarding the output device selected by the output device selecting section and the limited information corresponding to the selected output device, wherein the output section outputs thus selected image information when the output allowance determination section determines an output enable status of the image information.

The image processing apparatus according to the present invention can determine by itself whether or not printing is possible. Therefore, no setting is required for the plurality of the image forming apparatuses as the output devices for outputting the image information. In other words, the administrator can perform the setting with ease.

Hereinafter, the image processing apparatus according to the present invention is explained referring to the drawings. The image processing apparatus according to the present invention, however, is not limited to what is set forth below, but can be modified or changed as required without departing from the spirit and scope of the present invention.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein;

FIG. 1 is a block diagram illustrating an example of a schematic view of the image processing apparatus according to the present invention;

FIG. 2 is an example of an output device selecting screen containing an output device information of the image processing apparatus according to the present invention;

FIG. 3 is an example indicative of a setting screen containing limited information of the image processing apparatus according to the present invention;

FIG. 4 is a flow chart showing steps of setting process of the limited information of the image processing apparatus according to the present invention;

FIG. 5 is a flow chart showing steps of setting process of an output device information of the image processing apparatus according to the present invention;

FIG. 6 is a flow chart showing the steps of processing the printing instruction received from the image processing apparatus according to the present invention;

FIG. 7 is a block diagram illustrating an example of a schematic view of the image processing apparatus according to the present invention;

FIG. 8 is an example of a setting screen containing the limited information and information on an image sheet-number of the image processing apparatus according to the present invention;

FIG. 9 is a flow chart illustrating the steps of setting process of the limited information and the sheet-number-of-images information of the image processing apparatus according to the present invention;

FIG. 10 is a flow chart showing the steps of processing the printing instruction received from the image processing apparatus according to the present invention;

FIG. 11 is a block diagram illustrating an example of a schematic view of the image processing apparatus according to the present invention;

FIG. 12 is an example of a setting screen containing the limited information of the image processing apparatus according to the present invention;

FIG. 13 is an example of an attribute information setting screen containing the attribute information of the image processing apparatus according to the present invention;

FIG. 14 is a flow chart showing steps of setting process of the limited information of the image processing apparatus according to the present invention;

FIG. 15 is a flow chart showing the steps of processing the printing instruction received from the image processing apparatus according to the present invention;

FIG. 16 is an example of a query screen, in which the attribute information is modified, of the image processing apparatus according to the present invention; and

FIG. 17 is a flow chart showing the steps of processing the printing instruction received from the image processing apparatus according to the present invention.

### DETAILED DESCRIPTION OF THE INVENTION

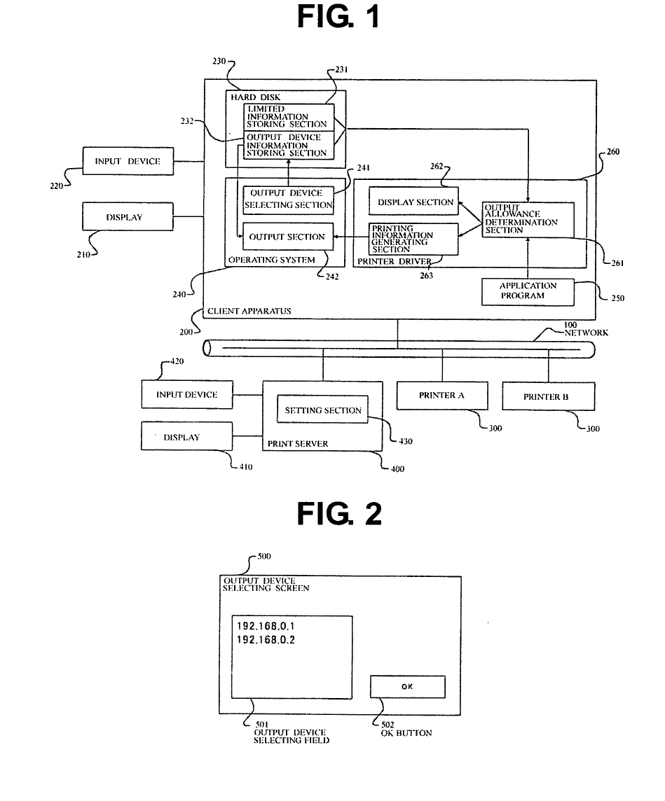

FIG. 1 is a block diagram illustrating a schematic view of the image processing apparatus according to the present invention. Client apparatus 200 as an image processing apparatus according to the present invention is connected through network 100 to printers 300 as an image forming apparatus and to print server 400. Client apparatus 200, printers 300 and print server 400 can communicate one another over network 100.

Client apparatus 200 is connected to network 100. Client apparatus 200 is also connected to display 210 for displaying predetermined information and to input device 220 such as a key board and a mouse for inputting information from the outside. Further, client apparatus 200 has hard disk 230, operating system 240, application program 250 and printer driver 260. Client apparatus 200 thus can send printing information to printers 300.

The printing information is data of image information capable of being printed by printers 300 and is generated by printer driver 260 based on the data of documents and/or images created by application program 250. This printing information can be printed by printers 300.

Hard disk 230 as an information storing section has limited information storing section 231 and output device information storing section 232. Limited information storing section 231 can store as limited information identification information permitted to be printed. Output device information storing section 232 can store as output device information the identification information capable of sending the printing information from client apparatus 200.

Operating system 240 for controlling the entire client apparatus 200 has output device selecting section 241 and output section 242. Output device selecting section 241 can display on display 210 output device selecting screen 500 in which an output device for receiving the transferred printing information such as shown in FIG. 2 is selected, and have output device information section 232 keep and store the output device information selected in accordance with an input by input device 220. Output section 242 can send the printing information to the output device in accordance with the output device information read out of output device information storing section 232.

Application program 250 is an ordinary software for creating documents, images or the like. The data of documents, images and the like created by application program 250 are notified to printer driver 260 through a printing instruction. At the same time, a name of one of printers 300 for printing the printing information to be generated based on this data is also notified.

Printer driver 260 is composed of output allowance determination section 261, display section 262 and printing information generating section 263. Application program 250 notifies output allowance determination section 261 of the data created by application program 250 in association with the name of the one of printers 300 for printing the printing information. Output allowance determination section 261 reads out of output device information storing section 232 the output device information corresponding to the notified name of the one of printers 300, thereby comparing the output device information with the limited information of limited information storing section 231. Output allowance determination section 261 thus determines as being printable if data corresponding to the output device information exists in the limited information. Adversely, output allowance determination section 261 determines as being unprintable if data corresponding to the output device information does not exist in the limited information.

Displaying section 262 can have display 210 display the information indicative of disable printing when output allowance determination section 261 determines as being disable printing. Accordingly, the administrator can learn such information before generation of the printing information indicative of disable printing. Therefore, the administrator can change the currently selected output device to the other one directly, thereby being able to shorten the time until start of printing. Printing information generating section 263, upon determination of disable printing by output allowance determination section 261, can generate the printing information from such data created by application program 250 to transfer the generated information to output section 242.

Printers 300 connected to network 100 are able to print onto print media on the basis of the printing information generated by printing information generating section 261.

Print server 400 connected to network 100 can set the limited information to be stored in limited information storing section 231 of client apparatus 200. Print server 400 is connected to display 410 serving to display and input device 420 such as a key board, a mouse and the like for inputting the information from the outside. The print server 400 has setting section 430.

Setting section 430 is capable of having display 410 display setting screen 600 in which the limited information and client apparatus 200 whereat the limited information is to be set is input. Setting section 430 is further capable of having limited information storing section 231 of client apparatus 200 store as the limited information the information input by input device 420.

FIG. 2 illustrates an example of an output device selecting screen. Output device selecting screen 500 is displayed on display 210 connected to client apparatus 200 through output device selecting section 241, in which an output device for receiving the printing information is selected. In the screen, there are displayed output device selecting field 501 and OK button 502. Output device selecting field 501 displays a list of output devices available with client apparatus 200, and the output device to be stored in output device information storing section 232 can be selected from the list. At this time, selected identification information may be highlighted. OK button 502 can have output device information storing section 232 store as output device information the identified information selected by output device selecting field 501. Output device selecting screen 500 then can be closed.

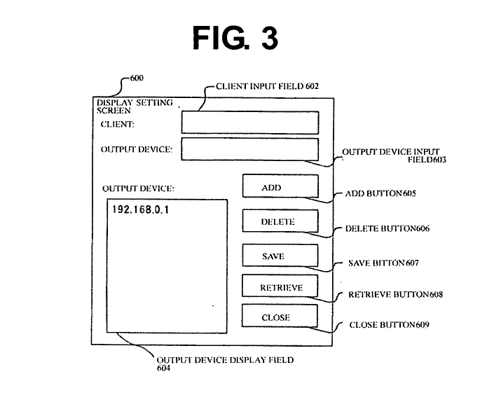

FIG. 3 illustrates an example of a setting screen. Setting screen 600 is displayed on display 410 connected to print server 400, and includes client input field 602, output device input field 603, output device display field 604, add button 605, delete button 606, save button 607, retrieve button 608 and close button 609.

Client input field 602 is input with a name of client apparatus 200 whereat the limited information is set. Output device input field 603 is input with the identification information for authorizing printing. Output device displaying field 604 displays the identification information for authorizing printing and the limited information. In the output device displaying field, the administrator can select the output device which he wishes to delete. Thus selected output device may be highlighted.

Add button 605 can add the identification information having been input into output device input field 603 to output device display field 604. Delete button 606 can delete the identification information selected by output device display field 604. Save button 607 is capable of having limited information storing section 231 of client apparatus 200 input in client input field 602 store the identification information displayed on output device displaying field 604 as the limited information. Retrieve button 608 reads the limited information out of limited information storing section 231 of client apparatus 200 having been input in client input field 602 to display the information on output device display field 604. Close button 609 can close the setting screen to terminate the setting process.

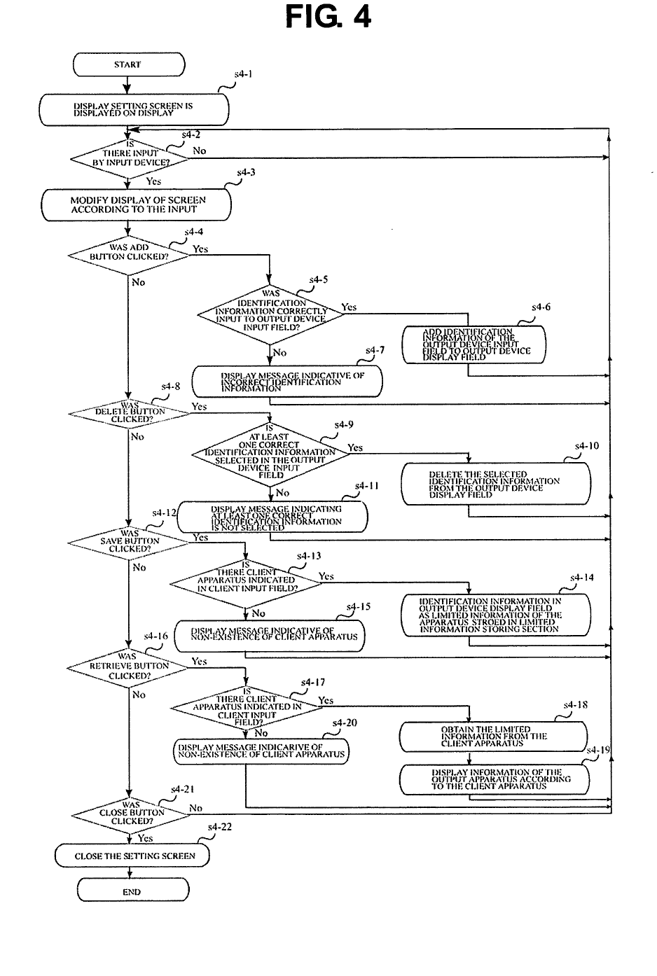

Hereinafter, behaviors of the image processing apparatus according to a first embodiment of the present invention are explained. At first, setting process of the limited information at setting section 430 is explained referring to FIGS. 1, 3 and 4. FIG. 4 is a flow chart showing steps of setting process of the limited information.

Initially, setting section 430 has display 410 display setting screen 600 in step s4-1. Then, whether or not an input by input device 420 exists is confirmed in step s4-2, and a display of the screen is so modified in accordance with the input if there exists the input by input device 420 in step s4-3. A click of either one of add button 605, delete button 606, save button 607, retrieve button 608 or close button 609 of setting screen 600 displayed on display 410 will execute the following process.

If add button 605 is clicked in step s4-4, whether or not a correct identification information has been input in output device input field 603 is determined in step s4-5. If the result thereof shows that the identification information has been input correctly, output device display field 604 displays the identification information correctly input in output device input field 603 in step s4-6, and the step returns to step s4-2. On the other hand, if the result of the determination in step s4-5 shows that the identification information has not been input correctly, a massage indicative of incorrect identification information is displayed, and the step returns to step s4-2. At this time, there may be a case where nothing has been input in output device input field 603.

If delete button 606 is clicked in step s4-8, whether or not at least one identification information displayed in output device display field 604 has been selected is determined in step s4-9. If the result shows that the output device has been selected, the selected identification information is to be deleted from output device display field 604 in step s4-10, and the step returns to step s4-2. On the other hand, if the result of step s4-9 shows that the output device has not been selected yet, a massage indicative of non-selection of the output device is displayed in step s4-11, and the step returns to step s4-2.

If save button 607 is clicked in step s4-12, whether or not there exists client apparatus 200 having been input in client input field 602 is determined in step s4-13. If the result shows that client apparatus 200 exists, the identification information of output device display field 604 as the limited information is stored in limited information storing section 231 in step s4-14, and the step returns to step s4-2. On the other hand, if the result of step s4-13 shows that client apparatus 200 does not exist, a message indicative of non-existence of client apparatus 200 is displayed in step s4-15, and the step returns to step s4-2.

If retrieve button 608 is clicked in step s4-16, whether or not there exists client apparatus 200 having been input in client input field 602 is determined in step s4-17. If the result shows that there exists client apparatus 200, the limited information is read out of limited information storing section 231 of client apparatus 200 in step s4-18. After retrieving the limited information, the identification information based on the limited information is displayed in output device display field 604 in step s4-19, and the step returns to step s4-2. On the other hand, the result of step s4-17 shows that there exists no client apparatus 200, an message indicative of non-existence of client apparatus 200 is displayed in step s4-20, and the step returns to step s4-2.

If close button 609 is clicked in step s4-21, setting screen 600 is closed in step s4-22, and terminates the setting process of the limited information.

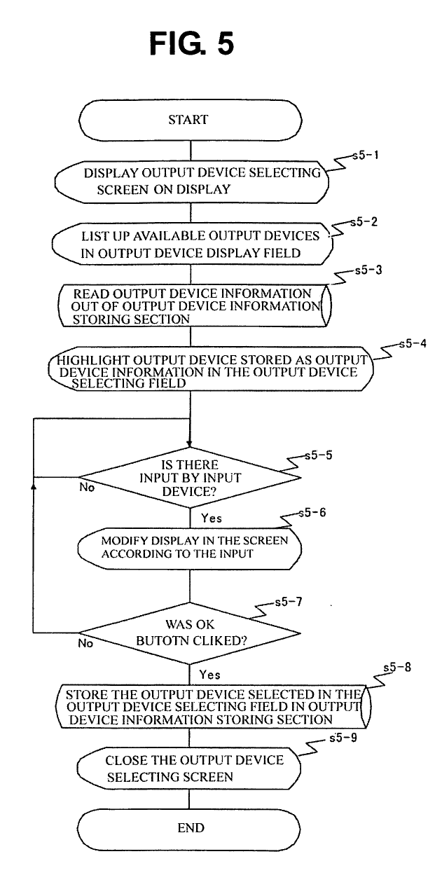

Setting process of the output device information in output device selecting section 241 is explained next referring to FIGS. 1, 2 and 5. FIG. 5 is a flow chart showing steps of setting process of the output device information.

Output device selecting section 241 displays output device selecting screen 500 on display 210 in step s5-1. After output device selecting screen 500 is displayed, the identification information available with client apparatus 200 is listed up in output device selecting field 501 in step s5-2. Subsequently, the output device information is read out of output device information storing section 232 in step s5-3. Then, the identification information stored as the output device information in output device selecting field 501 is highlighted in step s5-4.

If there is an input by input device 220 to highlight an output device which has not been highlighted for the purpose of adding a newly available output device in step s5-5, the display on the screen will be modified in accordance with the input in step s5-6.

If OK button 502 is clicked in step s5-7, the identification information selected in output device selecting field 501 as the output device information is stored in output information storing section 232 in step 5-8. After having the output device information storing section store the output device information, output device selecting screen 500 is closed in step s5-9, and this setting process of the output information is terminated.

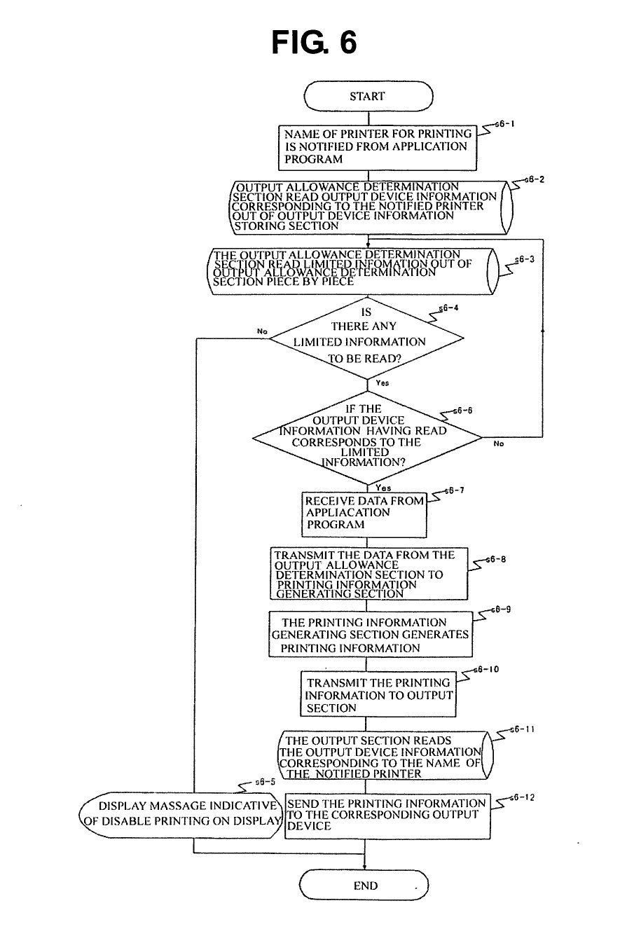

Process to be taken when printing instruction is given by client apparatus 200 is explained referring to FIGS. 1 and 6. FIG. 6 is a flow chart showing steps of process when the printing instruction is given.

When the printing instruction is given by application program 250, the name of the one of printers 300 for printing, e.g. printer A or Printer B, is notified to output allowance determination section 261. When the name of the one of printers 300 for printing is notified, output allowance determination section 261 reads out of output device information storing section 232 the output information corresponding to the one of printers 300 notified by application program 250 in step s6-2. After reading the output device information, output allowance determination section 261 reads the limited information piece by piece from limited information storing section 231 in step s6-3. Here, the limited information once read will not be read again in the same printing instruction.

Output allowance determination section 261 determines whether or not there is the limited information to be read in step s6-4. If the result shows that there is no more limited information to be read, display 210 has display section 262 display that printing is not possible, thereby terminating the process. If there still is the limited information to be read, the limited information having been read in step s6-6 is compared with thus read output device information of output information storing section 232 to determine whether or not those are corresponding to each other. If the result shows that those are not corresponding to each other, the step returns to step s6-3.

If the result of step s6-6 shows that those information are corresponding to each other, output allowance determination section 261 receives the data created by application program 250 in step s6-7. Thus received data is transmitted from output allowance determination section 261 to printing information generation section 263 in step s6-8. Printing information generating section 263 creates the printing information on the basis of the received data. Thus created printing information is transmitted to output section 242 in step s6-10. Output section 242 reads out of output device information storing section 231 the output device information corresponding to the name of the one of printers 300 in step s6-1 in order to print the printing information. Then, output section 242 sends the printing information to the output device corresponding to the output device information to finalize the process.

As described above, a printing allowance of the printing information is determined on the basis of the limited information containing the identification information having authorized the output. Therefore, in the image processing apparatus according to the present invention, no setting is required for any of printers 300 since client apparatus 200 per se determines whether it is printable or unprintable. That is to say, the administrator can perform the setting operation with ease. Further since the output device having been authorized to output is preliminary set, the printing allowance can be determined before generating the printing information, thereby capable of expecting shortening of the time for determination.

The image processing apparatus according to a second embodiment further has sheet-number information storing section 234 for storing the sheet-number limiting information in the hard disk of the image processing apparatus as explained in the first embodiment. The second embodiment is explained below with omitting the explanations of the substantially identical members to those having explained in the first embodiment.

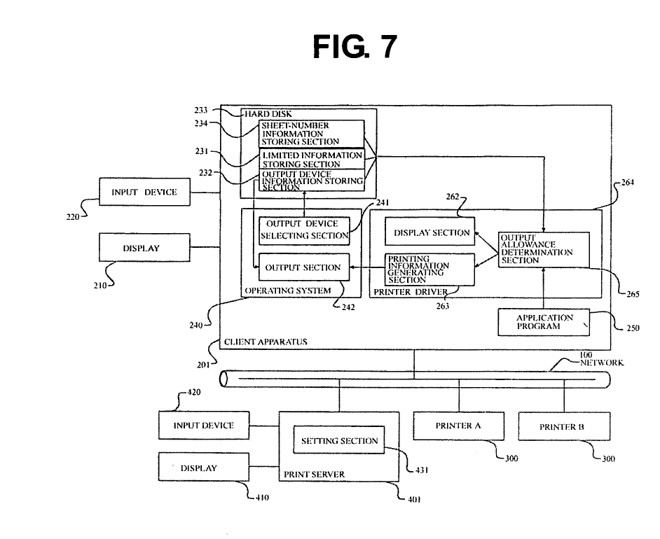

FIG. 7 is a block diagram illustrating an example of a schematic view of the image processing apparatus according to the present invention. Client apparatus 201 of the image processing apparatus according to the present invention is connected though network 100 to printers 300 and print server 401 as the image forming apparatus. Client apparatus 201, printers 300 and print server 401 are capable of communicating one another over network 100.

Client apparatus 201 is connected to network 100. Client apparatus 201 is further connected to display 210 for displaying a predetermined information and input device 220 such as a key board and a mouse for inputting information from the outside. Client apparatus 201 has hard disk 233, operating system 240, application program 250 and printer driver 264. Client apparatus 201 can send the printing information to printers 300.

The printing information is a data of an image information capable of being printed by printers 300 and is generated by printer driver 264 on the basis of the data of documents and/or images created by application program 250. This printing information is printable by printers 300.

Hard disk 233 serving as an information storing section has limited information storing section 231, output device information storing section 232 and sheet-number information storing section 234. Limited information storing section 231 can store as the limited information identification information in which the sheet-number of printable print media is limited not more than the predetermined sheet-number of print media. For example, limited information storing section 231 can store as the limited information the identification information in which the sheet-number of printable print media is limited not more than five, whereas the limited information storing section 231 cannot store such identification information of the output devices capable of printing more than five sheets of print media since such output devices are not given a limitation of the sheet-number of printable print media. Also, output device information storing section 232 can store as the output device information the identification information capable of sending the printing information from client apparatus 201. Sheet-number information storing section 234 can store as information on image sheet-number the sheet-number of print media printable by the output device according to the limited information stored in limited information storing section 231.

Operating system 240 for controlling the entire client apparatus 201 has output device selecting section 241 and output section 242. Output device selecting section 241 can display on display 210 the output device selecting screen in which the output device for receiving transmission of printing information is selected in the same manner as the first embodiment, and save and store the output device information selected by the input of input device 220 in output device information storing section 232. Output section 242 can send printing information to the output device according to the output device information read out of output device information storing section 232. An explanation of the output device selecting screen shall be omitted here since it has the same format as employed in the first embodiment.

Application program 250 is an ordinary software for creating documents, images and the like. The data such as documents and images created by application program 250 is notified though the printing instruction to printer driver 264. At this time, the name of the one of printers 300 for printing the printing information generated based on the data is also notified.

Printer driver 264 is composed of output allowance determination section 265, display section 262 and printing information generating section 266. Application program 250 notifies output allowance determination section 265 of the data created by application program 250 together with the name of the one of printers 300 for printing the printing information. Output allowance determination section 265 can transmit the notified data to printing information generating section 266 and receive the printing information generated based on the data in printing information generating section 266 and information on the sheet-number of print media necessary for printing the printing information as well. Output allowance determination section 266 compares the sheet-number of print media to be used with the sheet-number of print media according to the sheet-number-of-images information, and if the sheet-number of print media to be used is larger than the sheet-number of the print media according to the sheet-number-of-images information, the output device information in accordance with the name of the one of printers 300 notified by application program 250 is read out of output device information storing section 232 to compare the read output device information with the limited information of limited information storing section 231. Then, if there exists the information in accordance with the output device information in the limited information, the output allowance determination section 266 determines as being unprintable. Contrary thereto, if there does not exist the information in accordance with the output device information in the limited information, the output device to which the output device information is output is determined as being printable since such output device is capable of printing more sheet-number of print media than the sheet-number of the print media based on the sheet-number-of-images information. Output allowance determination section 266 compares the sheet-number of print media to be used with the sheet-number of the print media of the sheet number-of-images information and determines as being printable if the sheet-number of print media to be used is less than that of the sheet-number-of-images information.

Display section 262, if output allowance determination section 265 determines as being unprintable, can have display 210 display the information indicative of being unprintable. Accordingly, in the case where the printing is impossible, such information can be learned before generating the printing information thereof. Therefore, the administrator can change the currently selected output device to the other one directly, thereby capable of shortening the time to printing. Printing information generating section 266 generates the printing information based on the data created by application program 250 simultaneously with calculating the sheet-number of print media to be used to notify the printing information and the information of the sheet-number of print media to be used to output allowance determination section 265. Printing information generating section 266, if output allowance determination section 265 determines as being printable, can send the printing information to output section 242.

Printers 300 connected to network 100 are capable of printing print media on the basis of the printing information generated in printing information generating section 266.

Print server 401 connected to network 100 is capable of setting the limited information to be stored in limited information storing section 231 of client apparatus 201. Print server 401 also can set the number-of-images information to be stored in sheet-number information storing section 234. Print server 401 is connected to display 410 for displaying and input device 420 such as a key board and a mouse for inputting information from the outside. The print server has setting section 431.

Setting section 403 can have display 401 display setting screen 610 in which the limited information and the sheet-number-of-images information and client apparatus 201 for setting those information are input. Setting section 403 also can have limited information storing section 231 of client apparatus 201 store the information input by input device 420 as the limited information and have sheet-number information storing section 234 store this information as sheet-number-of-images information, respectively.

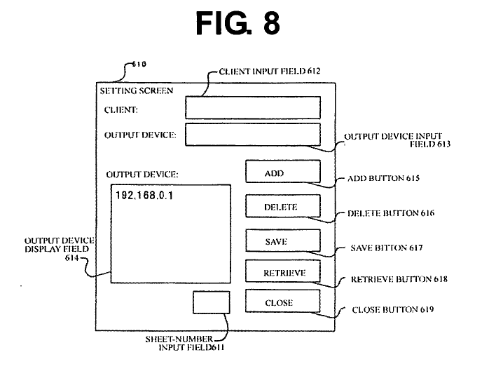

FIG. 8 is a view indicative of an example of a setting screen. Setting screen 610 is displayed on display 410 connected to print server 401 and contains number-of-print media input field 611, client input field 612, output device input field 613, output device display field 614, add button 615, delete button 616, save button 617, retrieve button 618 and close button 619.

Number-of-print media input field 611 is to be input with the sheet-number of printable print media by the output device in which the sheet-number of printable print media corresponding to the limited information stored in output limit information storing section 231 of client apparatus 201 to be set is limited. Client input field 612 is to be input with the name of client apparatus 201 to be set. Output device input field 613 is to be input with the identification information in which the sheet-number of printable print media is limited. Output device display field 614 displays the identification information in which the sheet-number of printable print media is limited. In the output device display field 614, the output device wished to be deleted can be selected therein. Thus selected identification information may be highlighted.

With add button 615, the identification information input in output device input field 613 can be added to output device display field 614. With delete button 616, the identification information selected in output device display field 614 can be deleted. With save button 617, limited information storing section 231 of client apparatus 201 input in client input field 612 can store the identification information displayed in output device display field 614 as the limited information, and sheet-number information storing section 234 of client apparatus 201 to be input in client input field 612 can store the number of print media input in number-of-print media input field 611 as sheet-number-of-images-information. With retrieve button 618, the limited information and the sheet-number-of-images-information can be read out of limited information storing section 231 and sheet-number information storing section 234 of client apparatus 201 input in client input field 612, and output device display field 614 can display those information. With close button 619, this setting process can be terminated upon closing the setting screen.

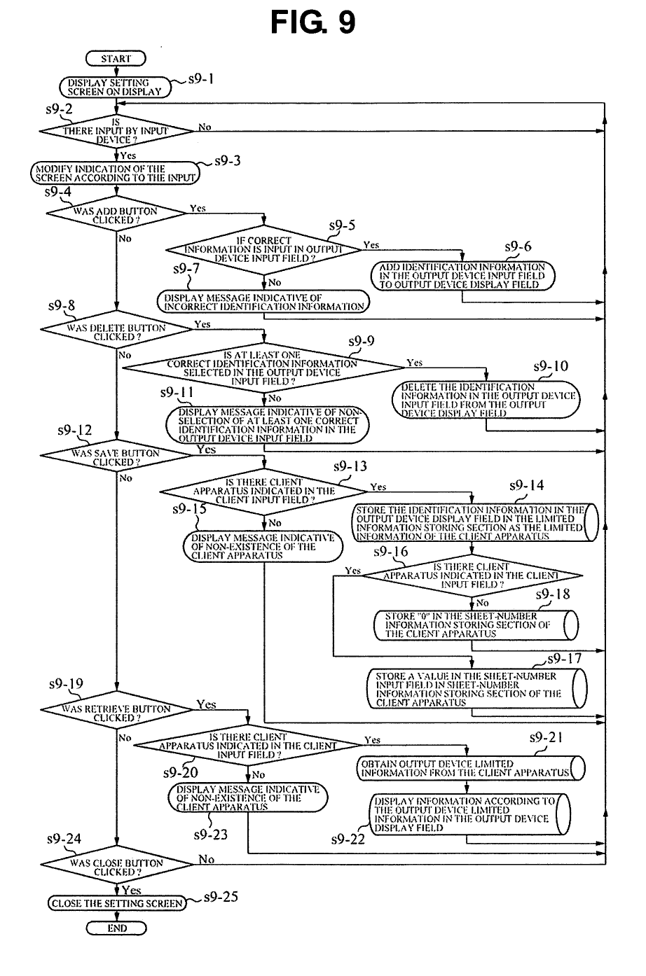

Hereinafter, behaviors of the image processing apparatus according to the second embodiment are explained. Setting process of the limited information and the sheet-number-of-images-information in setting section 431 is explained referring to FIGS. 7, 8 and 9. FIG. 9 is a flow chart showing the steps of setting process of the limited information and the information on the image sheet-number.

Initially, setting section 431 has display 410 display setting screen 610 in step s9-1. Then, whether or not an input by input device 420 exists is confirmed in step s9-2, and indication of the screen is modified according to the input if there is the input by input device 420 in step s9-3. A click of any one of add button 615, delete button 616, save button 617, retrieve button 618 or close button 619 in setting screen 610 displayed on display 410 will execute the following processes.

If add button 615 is clicked in step s9-4, whether or not identification information is correctly input in output device input field 613 is determined in step s9-5. If the result shows that the identification information is correctly input, the identification information input in output device input field 613 is displayed in output device display field 614 in step s9-6, and the step returns to step s9-2. On the other hand, if the result in step s9-5 shows that the identification information is not input correctly, a message indicative of incorrect identification information is displayed in step s9-7, and the step returns to step s9-2. At this time, the case where nothing is input in output device input field 613 is also considered as being incorrect information.

If delete button 616 is clicked in step s9-8, whether or not at least one identification information displayed in output device displaying field 614 is selected is determined in step s9-9. If the result shows that at least one identification information has been selected, thus selected identification information is deleted from output device displaying field 614 in step s9-10, and the step returns to step s9-2. On the other hand, if the result of determination in step s9-9 shows that no identification information has been selected, a message indicative of non-selection of the at least one identification information is displayed in step s9-11, and the step returns to s9-2.

If save button 617 is clicked in step s9-12, whether or not client apparatus 201 input in client input field 612 exists is determined in step s9-13. If the result shows that client apparatus 201 exists, the identification information of output device displaying field 614 as the limited information is stored in limited information storing section 231 in step s9-14. Then, whether or not there is an input in sheet-number-of-print media input field 611 is determined in step s9-16. If there is the input, the sheet-number of print media input in number-of-print media input field 611 as the sheet-number-of-images-information is stored in sheet-number information storing section 234 in step s9-17, and the step returns to s9-2. If there is no input, the sheet-number of print media input in the sheet-number-of-print media input field 611 is set to be “0”0 in step s9-18, having sheet-number information storing section 234 store “0” as the sheet-number-of-images-information, and the step returns to step s9-2. At this time, the fact that the sheet-number of print media is not input in sheet-number-of-print media input field 611 may be displayed on display 410. On the other hand, the result of determination in step s9-13 shows that there is no client apparatus 201, a message indicative of non existence of client apparatus 201 is displayed in step s9-15, and the step returns to step s9-2.

If retrieve button 618 is clicked in step s9-19, whether or not client apparatus 201 input in client input field 612 exists is determined in step s9-20. If the result shows that client apparatus 201 exists, the limited information and the sheet-number-of-images-information are read out of limited information storing section 231 and sheet-number information storing section 234 of client apparatus 201 in step s9-21. After obtaining the limited information and the sheet-number-of-images-information, the limited information is displayed in output device display field 614 in step s9-22 and the sheet-number-of-images-information is displayed in number-of-print media input field 611 as well, and the step returns to step s9-2. On the other hand, the result of the determination in step s9-20 shows that there is no client apparatus 201, the message indicative of non existence of client apparatus 201 is displayed in step s9-23, and the step returns to s9-2.

If close button 619 is clicked in step s9-24, setting screen 610 is closed in step s9-25 to terminate the setting process of the limited information and the printing information.

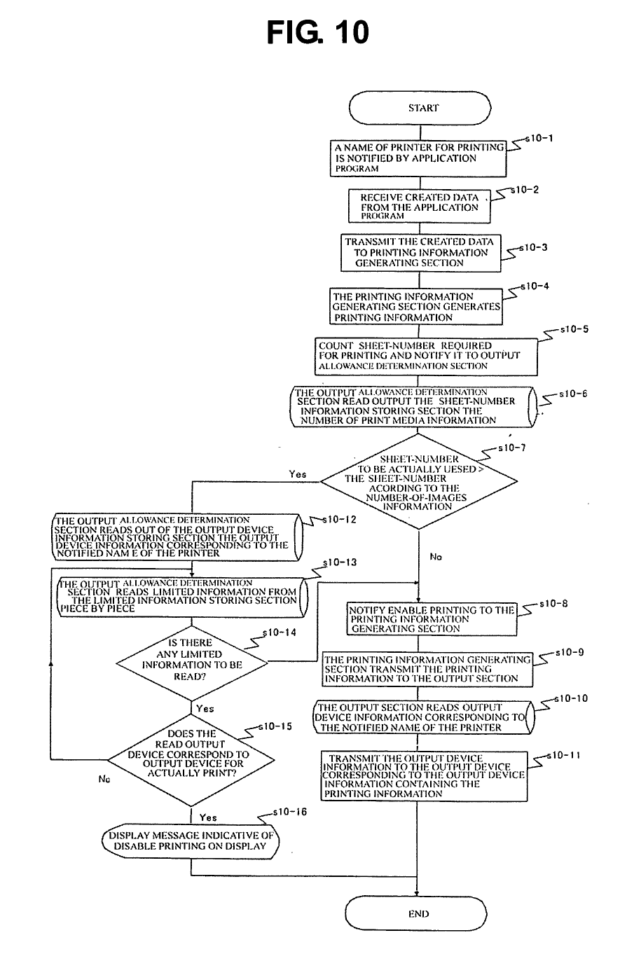

Processes in response to the printing instruction by client apparatus 201 is explained next referring to FIGS. 7 and 10. FIG. 10 is a flow chart showing the steps in response to the printing instruction.

Application program 250 notifies the name of the one of printers 300, such as printer A and printer B, for printing in step s10-1 in a case of sending the printing instruction. When the name of the one of printers 300 for printing is notified, output allowance determination section 265 receives data created by application program 250 in step s10-2. Output allowance determination section 265 transmits the data to printing information generating section 266 in step s10-3. Printing information generating section 266 generates printing information based on the data in step s10-4. At this time, printing information generating section 266 calculates the sheet-number of print media to be used for printing the printing information to notify the information of the sheet-number to output allowance determination section 265 in step s10-5.

Output allowance determination section 265 to which the sheet-number to be used is notified reads the sheet-number-of-images-information out of sheet-number information storing section 234 in step s10-6. Then, output allowance determination section 265 compares thus read out sheet-number according to the sheet-number-of-images-information with such the sheet-number to be used as notified by printing information generating section 266 to determine whether or not the sheet-number to be used is larger than the-sheet number according to the sheet-number-of-images-information.

If the result shows that the sheet-number to be used is larger than the sheet-number according to the sheet-number-of-images-information, output allowance determination section 265 reads out of output device information storing section 232 the output device information corresponding to the name of the one of printers 300 for printing in step s10-12. After reading the output device information, output allowance determination section 261 reads out of limited information storing section 231 the limited information piece by piece in step s10-13. At this time, the limited information once read will not be read again in the same printing instruction.

At the same time as above, output allowance determination section 265 determines whether or not the limited information to be read exists in step s10-14. If the result shows there is no limited information to be read, the output allowance determination section 265 will indicate the output device corresponding to the name of the one of printers 300 which is instructed for printing is such that allowing the printable sheet-number to be used according to the sheet-number-of-images-information not to be limited, or namely that can print without limitation of the sheet-number, so that the step goes to step s10-8 to process such that the printing information is printed. On the other hand, if the result of determination in step s10-14 shows that the limited information to be read exists, output allowance determination section 265 compares the output device information with the limited information to determine whether or not they correspond to each other in step s10-15. If they do not correspond to each other, the step returns to step s10-13. The result of determination in step s10-15 shows they correspond to each other, since the output device corresponding to the name of the notified printer attempts to print as many as the sheet-number more than those limited, the output allowance determination section 265 has display section 262 display on display 210 the indication of being unprintable in step s10-16 to terminate the process.

If the sheet-number to be printed is less than the sheet-number according to the sheet-number-of-images-information, output allowance determination section 265 notifies to printing information generating section 266 as being printable in step s10-8. Then, printing information generating section 266 transmits thus generated printing information to output section 242 in step s10-9. Output section 242 upon receiving the printing information, reads out of output device information storing section 232 the output device information corresponding to the name of the one of printers 300 in step s10-10. Then, output section 242 sends the printing information to the output device corresponding to thus read output device information to terminate the process.

As described above, printing allowance of the printing information can be determined according to the sheet-number-of-images-information which limits the number of outputable print media and the limited information containing the limited identification information. That is, the image processing apparatus according to the present invention is featured in that client apparatus 201 per se determines whether printable or not, so that no settings are required for printers 300. Accordingly, the administrator can perform setting operation with ease. Further, the setting of the sheet-number-of-images-information can limit the output device according to the sheet number to be printed.

The image processing apparatus described in a third embodiment has attribute information setting section 270 for setting attribute information to the printer driver as explained in the first embodiment. This image processing apparatus will be explained hereinafter; however, the members identical to those as already explained in the first and the second embodiments are omitted of their explanations.

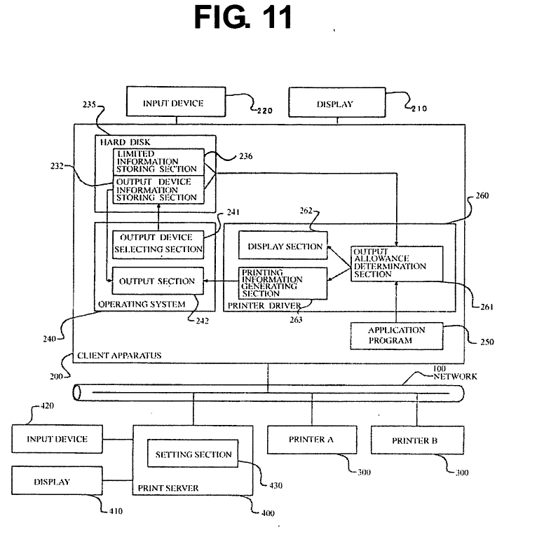

FIG. 11 is a block diagram illustrating an example of schematic view of the image processing apparatus according to the present invention. Client apparatus 202 serving as the image processing apparatus according to the present invention is connected to printers 300 as the image forming apparatus and print server 404 through network 100. Client apparatus 202, printers 300 and print server 402 can communicate each other over network 100.

Client apparatus 202 is connected to network 100. Client apparatus 202 is further connected to display 210 for displaying predetermined information and input device 220 such as a key board and a mouse for inputting information from the outside. Further, client apparatus 202 has hard disk 235, operating system 240, application program 251 and printer driver 267. Client apparatus 201 can send the printing information to printers 300.

The printing information is a data of the image information capable of being printed by printers 300 and can be generated by printer driver 267 based on the data of documents and images created by application program 251. This printing information can be printed by printers 300.

Hard disk 235 as an information storing section has limited information storing section 236 and output device information storing section 232. Limited information storing section 236 can store the identification information in which color printing is authorized, as the limited information. Output device information storing section 232 further can store as the output device information the identification information capable of sending the printing information from client apparatus 200.

Operating system 240 for controlling the entire client apparatus 202 has output device selecting section 241 and output section 242. Output device selecting section 241 can have display 210 display the output device selecting screen in which the output device for receiving the printing information is selected in the same manner as stated in the first embodiment and have output device information storing section 232 save and store the output device information selected by an input of input device 220. Output section 242 can send the printing information to the output device in accordance with the output device information read out of output device information section 232. The output device selecting screen is identical to that of the first embodiment, and therefore the setting process thereof is also the same, so that the explanation thereof is omitted here.

Application program 251 is an ordinary software for creating documents and images and the like. The data of documents, images and the like created by application program 251 are notified to printer driver 267 through the printing instruction. At this time, the name of the one of printers 300 for printing the printing information created based on the above data is also notified. Application program 251 also calls up attribute information setting section 270 from printer driver 267 and retrieves the information indicative of whether thus created data is printed in color or in monochrome as the attribute information. This attribute information is transmitted to printer driver 267 following the printing instruction.

Printer driver 267 is composed of output allowance determination section 268, display 262, printing information generating section 269 and attribute information setting section 270. Application program 251 notifies output allowance determination section 268 of the data created by application program 251, the attribute information and the name of the one of printers 300 for printing the printing information. Output allowance determination section 261 determines as being printable based on the attribute information if the data contains monochrome printing information. On the other hand, if the data contains color printing information, the output device information corresponding to the name of thus notified printer is read out of output device information storing section 232 to be compared with the limited information of limited information storing section 231. Then, if there is information in accordance with the output device information in the limited information, output allowance determination section 268 determines as being printable. Adversely, output allowance determination section 268 determines as being unprintable if there isn't information corresponding to the output device information in the limited information.

Display section 262, when output allowance determination section 268 determines as being unprintable, can have display 210 display the information indicative of being unprintable. With such structure, in the case of determination of color printing disable status, such information is obtainable before generating the printing information and thus the attribute information is changeable. Printing information generating section 269, in the case where output allowance determination section 261 determines as being printable, can generate the printing information based on the attribute information received from and data created by application program 251 and transmit the resulting information to output section 242.

Attribute information setting section 270, upon being called up by application program 251, can have display 210 display attribute information setting screen 700 as shown in FIG. 13. Attribute information setting section 270 can transmit the attribute information selected by an input of input device 220 to application program 251.

Printers 300 connected to network 100 each can print onto print media based on the printing information and the attribute information generated in printing information generating section 269.

Print server 402 connected to network 100 can set the limited information to be stored in limited information storing section 236 of client apparatus 202. Print server 402 having setting section 432 is connected to display 410 for displaying and input device 420 such as a key board and a mouse for inputting information from the outside.

Setting section 432 can have display 410 display setting screen 630 in which the limited information and client apparatus 202 for setting such information are input. The setting section 432 further can have output limited information storing section 236 of client apparatus 202 store the information input by input device 420 as the limited information. Since the process of setting of the output information at setting section 432 though setting screen 630 is identical to that described in the first embodiment, the explanation thereof is omitted here.

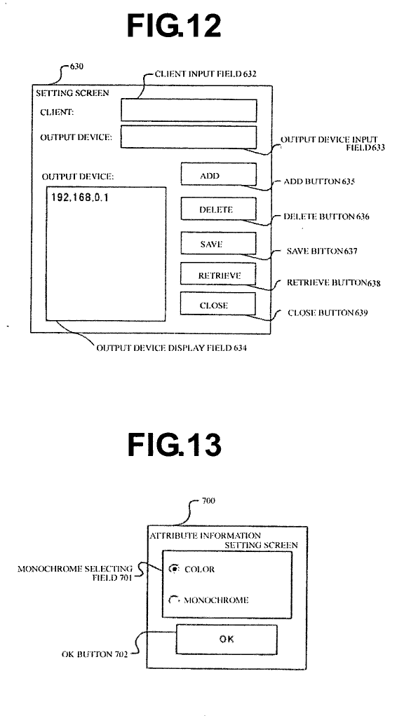

FIG. 12 is a view illustrating an example of a setting screen. Setting screen 630 displayed on display 410 connected to print server 402 includes client input field 632, output device input field 633, output device display field 634, add button 635, delete button 636, save button 637, retrieve button 638 and close button 639.

The name of client apparatus 202 for setting the limited information is input in client input field 632. The identification information for authorizing color printing is input in input device input field 633. Identification information for authorizing color printing is displayed on output device display field 634. The administrator can select the output device which he wishes to delete. Thus selected identification information may be highlighted.

With add button 635, the identification information input in output device input field 633 can be added to output device display field 634. With delete button 636, the identification information selected by output device display field 634 can be deleted. With save button 637, limited information storing section 236 of client apparatus 202 input in client input field 632 can store the output device displayed in output device displaying field 634 as the limited information. With retrieve button 638, the limited information can be read out of limited information storing section 236 of client apparatus 202 input in client input field 632 to be displayed in output device displaying field 634. With close button 639, the setting screen can be closed to terminate the setting process.

FIG. 13 is a view illustrating an example of a setting screen of the attribute information. Attribute information setting screen 700 is displayed on display 210 connected to client apparatus 202, in which whether the data created by application program 251 is to be subjected to color printing or monochrome printing is selected. The attribute information setting screen includes color/monochrome selecting field 701 and OK button 702. With color/monochrome selecting field 701, whether the data created by application program 251 is subjected to color printing or monochrome printing can be selected. In FIG. 13, for example, “monochrome” is made to be in non-selected status if “color” is selected, and “color” is made in non-selected status if “monochrome” is selected. With OK button 702, the data indicative of whether the data will be printed in color or monochrome in accordance with the selection in color/monochrome selecting field 701 can be transmitted as the attribute information to application program 251 and attribute information setting screen 700 can be thereafter closed.

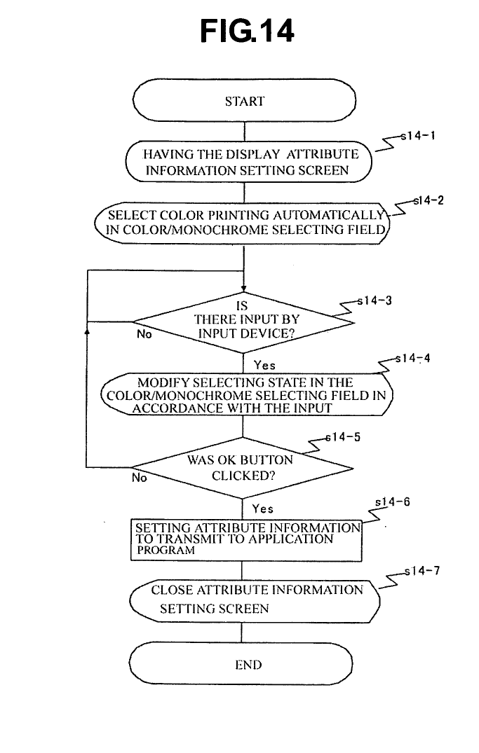

Hereinafter, an operation of the image processing apparatus according to the third embodiment will be explained. A setting operation of the attribute information in attribute information setting section 270 will be explained referring to FIGS. 11, 13 and 14. FIG. 14 is a flow chart illustrating steps of setting process of the attribute information.

Attribute information setting section 270 will be called up by an instruction of application program 251 when setting whether the data of documents, images and the like created by application program 251 are printed in color or monochrome. Then, the attribute information setting section has display 210 connected to client apparatus 202 display attribute information setting screen 700 as shown in FIG. 13 in step s14-1. After having display 210 display attribute information setting screen 700, attribute information setting section 270 automatically makes color/monochrome selecting field 701 in a state where color printing is selected in step 14-2.

Subsequently, attribute information setting section 270 confirms whether or not there is the input of input device 420 in step s 14-3, and modifies the indication in the screen based on the input if there is the input of input device 420 in step s14-4. Attribute information setting section 270 confirms whether or not OK button 702 has been clicked in step s14-5. If OK button 702 has been clicked, attribute information setting section 270 sets the attribute information based on the information indicative of whether color printing or monochrome printing is to be performed as a result of a selection in color/monochrome selecting field 701 in step s14-6 and transmits thus set attribute information to application program 251. Attribute information setting section 270, after transmitting the attribute information to application program 251, closes the attribute information selecting screen in step s-14-7.

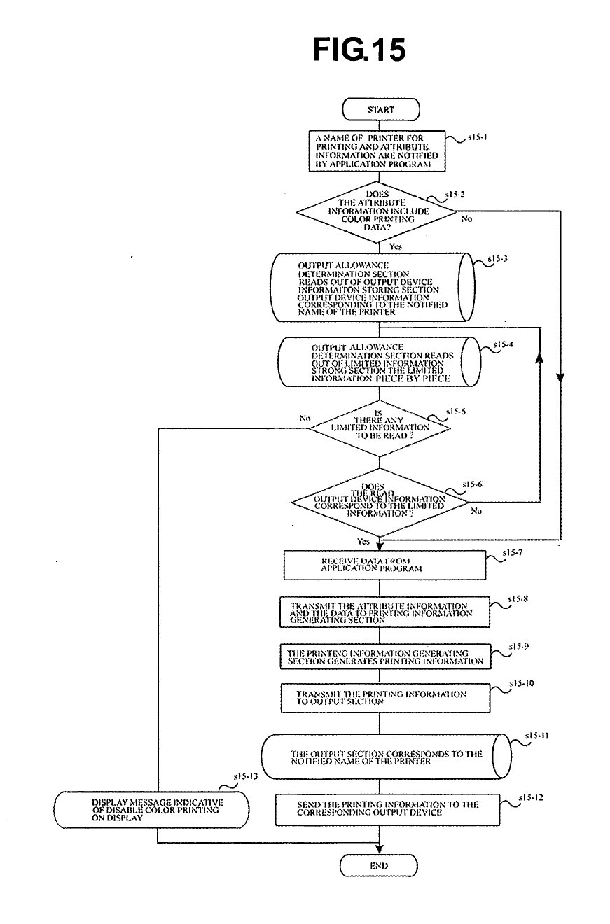

Process upon reception of the printing instruction from client apparatus 202 is explained referring to FIGS. 11 and 15. FIG. 15 is a flow chart illustrating steps of process when the printing instruction is given.

In the case where the printing instruction is given by application program 251, the attribute information will be notified to output allowance determination section 268 together with the name of the one of printers 300 such as printer A or printer B for printing. Output allowance determination section 268 then determines whether color printing or monochrome printing is to be performed in view of the attribute information in step s15-2. If the attribute information contains the color print information, output allowance determination section 268 reads out of output device information storing section 232 the output device information corresponding to the name of the notified name of the one of printers 300 in the step s15-3. Output allowance determination section 268 reads the output device information and subsequently the limited information piece by piece from limited information storing section 236 in step s15-4. At this time, the limited information once read will not be read again in the same printing instruction.

Output allowance determination section 268 determines if there is the limited information to be read in step s15-5. If the result shows that there is no limited information to be read, the output allowance determination section 268 has display section 262 display the unprintable status on display 210 in step s15-13 because the output device is not authorized to perform color printing, and then the process is terminated. If the result shows that there is the limited information to be read, the output allowance determination section 268 compares the limited information having been read in step s15-6 with the output device information having been read to determine whether or not the limited information and the output device information correspond to each other. If they do not correspond to each other, the step returns to step s15-4.

If a result of determination in step s15-6 shows they correspond to each other, output allowance determination section 268 receives the data created by application program 251 in step s15-7. Then, output allowance determination section 268 transmits thus received data together with the attribute information to printing information generating section 269 for generating the printing information. Printing information generating section 269 having received the data and the attribute information generates the printing information on the basis of the data and the attribute information. Printing information generating section 269 transmits the printing information to output section 242 in step s15-10. Output section 242 upon receiving the printing information reads the output device information corresponding to the name of the one of printers 300 notified by output device information storing section 232 in step s15-11. Then, output section 242 sends the printing information to the output device corresponding to thus read output device information to terminate the process.

As stated above, printing allowance of the printing information can be determined in view of the attribute information indicative of whether the printing information to be printed by printers 300 is to be subjected to color printing or monochrome printing and the limited information containing the identification information in which the attribute information authorizes the output of image information. That is to say, no setting is required for printers 300 since the image processing apparatus of the present invention is capable of determining if client apparatus 202 can print or not. Therefore, the administrator can perform the setting operation with ease. Preliminary setting of output device to be authorized to print on the basis of the attribute information containing information whether color printing or monochrome printing is to be performed will make it possible to determine the printing allowance before generating the printing information.

The image processing apparatus as described in the third embodiment upon receiving the printing instruction displays the information indicative of being unprintable, in the case where there is the attribute information to print in color and where printer 300 to which the printing instruction is given is not authorized to print in color. At this time, instead of displaying the information indicative of being unprintable, a screen indicating that a printing mode is changed to monochrome printing as set force below can be displayed and thus the attribute information may be changed from color printing to monochrome printing.

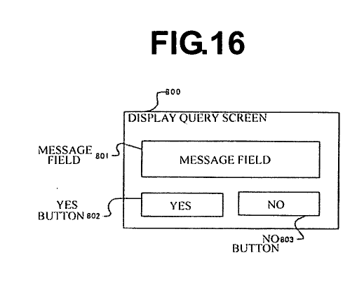

Here, if output allowance determination section 268 determines as being unprintable, displaying section 262 has display 210 connected to client apparatus 202 display query screen 800 as shown in FIG. 16. In the case where the information in which the attribute information of the data created by application program 251 is to be printed in color is changed to the information in which such attribute information is to be printed in monochrome, display section 262 can notify thus changed attribute information to output allowance determination section 268. With this notification, output allowance determination section 268 transmits the attribute information containing monochrome printing information and thus created data to printing information generating section 266, thereby generating the printing information. Thus created printing information is transmitted to output section 242 and printed by the one of printers 300 for printing.

Query screen 800 as exemplified in FIG. 16 includes massage field 801, YES button 802 and NO button 803. Massage field 801 displays a massage indicating whether the administrator wishes to change the printing mode into monochrome printing or not on the condition that color printing is impossible. With YES button 802, the attribute information can be changed such that the color printing information is modified to the monochrome printing information and query screen 800 can be closed to terminate modification process of this attribute information. With NO button 803, query screen 800 can be closed without modifying the attribute information to terminate the modification process of this attribute information.

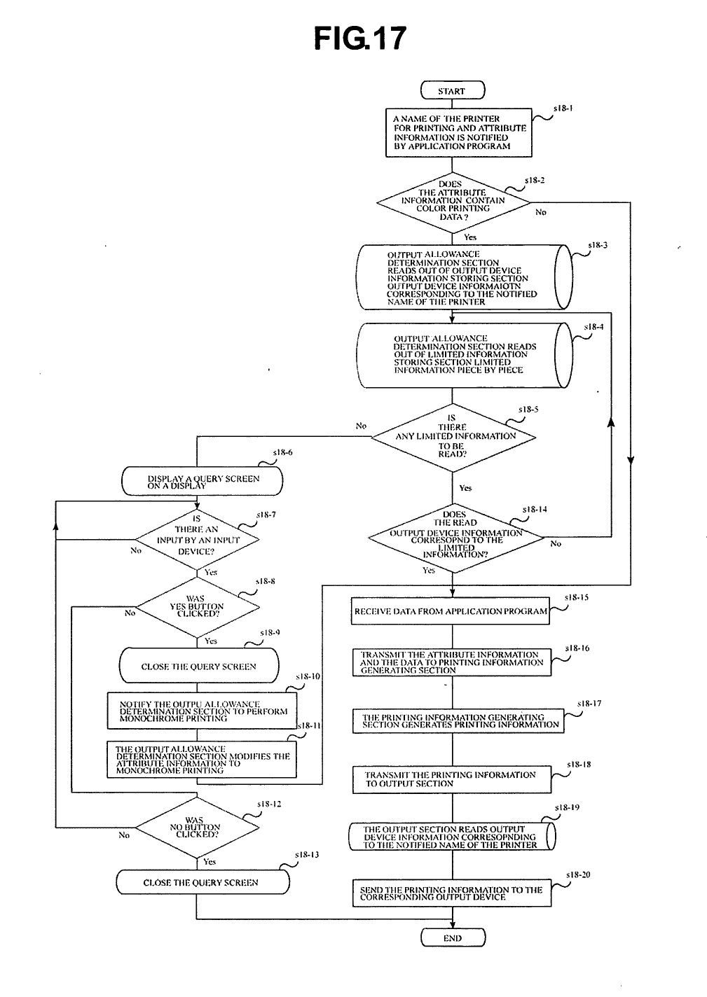

Described referring to FIGS. 11 and 17 is a process of steps in which client apparatus 202 sends the printing instruction in the case where the attribute information can be modified in query screen 800 as stated above. FIG. 17 is a flow chart illustrating process of steps upon receiving the printing instruction.

When application program 251 sends the printing instruction, application program 251 also notifies output allowance determination section 268 of the attribute information together with the name of the one of printers 300 for printing such as printer A or printer B. Output allowance determination section 268 then determines if the attribute information contains the color printing information in step s17-2. If the attribute information does not contain the color printing information, namely if it contains monochrome printing information, the step goes to step s17-15 since the monochrome printing is not limited, thereby being able to perform printing based on the data. On the other hand, a result of the determination in step s17-2 shows that the attribute information contains the color printing information, output allowance determination section 268 reads out of output device information storing section 232 the output device information corresponding to the name of the one of printers 300 notified in step s17-3. Output allowance determination section 268 having read the output device information reads out of limited information storing section 236 the limited information piece by piece in step s17-4. At this time, the limited information once read will not be read again in the same printing instruction.

Output allowance determination section 268 confirms whether or not there is the limited information to be read in step s17-5. If a result thereof shows that there is the limited information to be read, the limited information having been read is compared with the output device information having been read to determine if they correspond to each other in step s17-14. If a result of the determination shows that they do not correspond to each other, the step returns to step s15-4. If the determination result in step s17-14 shows that they correspond to each other, the step goes to step s17-15 to print based on the data.

On the other hand, if a result of determination in step s18-5 shows that there is no limited information to be read, display section 262 has display 210 display query careen 800 in step s17-6. Display section 262, after having display 210 display the query screen, confirms if there is an input of input device 220. If there is the input of the input device, display section 262 confirms whether or not YES button 802 has been clicked in step s17-8. Display section 262 in response to the click of YES button 802 closes query screen 800 in step s18-9. Then, display section 262 notifies output allowance determination section 268 of the information in which the attribute information is to be printed in monochrome in step s18-19. Output allowance determination section 268 subsequently modifies the attribute information in response to this notification in step s17-11. After the modification of the attribute information, the step goes to step s17-15 to perform printing based on the data. If YES button 802 has not been clicked in step s17-8, the output allowance determination section 268 confirms whether or not NO button 803 has been clicked. If NO button 803 has been clicked, query screen 800 is closed to terminate the process.

Output allowance determination section 268, upon receiving authorization of printing, receives the created data from application program 251 in step s17-15. Output allowance determination section 268 then transmits in step s17-16 thus received data together with the attribute information to printing information generating section 269 for generating the printing information. Printing information generating section 269 having received the data and the attribute information generates the printing information on the basis of the data and the attribute information in step s17-17. Printing information generating section 269 transmits the printing information to output section 242 in step s17-18. Output section 242 upon receiving the printing information reads out of output device information storing section 232 the output device information corresponding to the name of the one of the printer 300 for printing in step s17-19. Output section 242 sends the printing information to the output device corresponding to the output device information having been read in step s17-20 to terminate the process.

As described above, the attribute information of the printing information can be converted to another attribute information, for example, from the color printing to the monochrome printing. That is, the image processing apparatus according to the present invention can still perform printing with another attribute information even if the output allowance determination section 268 determines as being unprintable. Since client apparatus 202 per se determines if it is printable or not, no setting is required for printers 300. Therefore, the administrator can perform the setting operation with ease.

In the embodiments, the image processing apparatus having one client apparatus is exemplified; however, the number of client apparatuses is not limited to one but can be plural. An example in which hard disk 230 is used as the limited information storing section is disclosed here; however, such a limited information storing section is not limited to the one disclosed here but can be any recording medium, for example, disk-like media such as digital versatile disk, compact disk or the like, recording medium using semiconductors such as flash memories. Further, the limited information storing section here is included in the hard disk of the client apparatus, which also may be included in the hard disk of the print server.

In the embodiments, a case where two printers 300 such as printer A and printer B are connected to the image processing apparatus is explained here; however, the number of such printers 300 is not necessarily specified, but may be one or more than three. Printers are exemplified here as the image forming apparatuses; however, the present invention is not limited to such examples but copying machines or multi-function printers (MFP) are also applicable as the image forming apparatuses. Further, the network connection is exemplified here as a connection between the client apparatus and the printers or the like; however, a parallel connection or universal serial bus (USB) connection are also applicable to the present invention.

As described above, it is obvious that this invention can be arbitrarily modified without departing from the scope of this invention.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An image processing apparatus connected to a plurality of image forming apparatuses as output devices of image information, the image processing apparatus for selecting one of the plural image forming apparatuses and for outputting the image information to the selected image forming apparatus, comprising:
an output device selecting section for selecting one of the plurality of the output devices;
an output section for outputting the image information to the output device selected by the output device selecting section;
a limited information storing section for storing limited information for limiting an output of the image information in accordance with each of the plural output devices; and
an output allowance determination section for determining whether the output of the image information is allowed or not to the selected output device based on the output device information regarding the output device selected by the output device selecting section and the selected limited information corresponding to the selected output device,
wherein the output section outputs the selected image information when the output allowable determination section determines that the output of the image information is possible.

2. The image processing apparatus according to claim 1, further comprising a display section for displaying an image in response to a determined result by the output allowance determination section, wherein the display section displays that an output of the image information to the selected output device is not allowed when the output allowance determination section determines that the output of the image information to the selected output device is not allowed.

3. The image processing apparatus according to claim 1, wherein the limited information contains identification information for identifying each of the plural image forming apparatuses as the output devices and wherein the output device selecting section selects the output device based on the identification information.

4. The image processing apparatus according to claim 1, wherein the limited information contains sheet-number-of-images-information capable of being output to each of the plural image forming apparatuses as the output devices and wherein the output allowance determination section determines allowance output of the image information based on the sheet-number-of-images-information.

5. The image processing apparatus according to claim 1, wherein the image information contains attribute information indicative of an attribute of the image information and wherein the output allowance determination section determines whether or not the output of the image information is allowed based on the attribute information.

6. The image processing apparatus according to claim 5, wherein the output allowance determination section converts the attribute information contained in the image information to another attribute information when the output of the image information is determined as being not allowed based on the attribute information.

7. The image processing apparatus according to claim 5, wherein the attribute information includes information regarding capability for monochrome printing and multicolor printing.

8. An image processing apparatus connected to a plurality of image forming apparatuses as output devices of image information, the image processing apparatus for selecting one of the plural image forming apparatuses and for outputting the image information to the selected image forming apparatus, comprising:
an output device selecting section for selecting one of the plurality of the output devices;
an output section for outputting the image information to the output device selected by the output device selecting section;
a limited information storing section for storing limited information for limiting an output of the image information in accordance with each of the plural output devices;
an output device information storing section for storing output device information and for outputting the output device information regarding the output device selected by the output device selecting section; and
an output allowance determination section for determining whether the output of the image information is allowed or not allowed to the selected output device based on the output device information transmitted from the output device information storing section and the selected limited information corresponding to the selected output device,
wherein the output section outputs the selected image information when the output allowable determination section determines that the output of the image information is possible.

9. The image processing apparatus according to claim 8, wherein the output device information storing section stores the output device information including identification information which one of image forming apparatuses can accept the image information.

10. The image processing apparatus according to claim 8, further comprising a display section for displaying an image in response to a determined result by the output allowance determination section, wherein the display section displays that an output of the image information to the selected output device is not allowed when the output allowance determination section determines that the output of the image information to the selected output device is not allowed.

11. The image processing apparatus according to claim 8, wherein the limited information contains identification information for identifying each of the plural image forming apparatuses as the output devices and wherein the output device selecting section selects the output device based on the identification information.

12. The image processing apparatus according to claim 8, wherein the limited information contains sheet-number-of-images-information capable of being output to each of the plural image forming apparatuses as the output devices and wherein the output allowance determination section determines allowance output of the image information based on the sheet-number-of-images-information.

13. The image processing apparatus according to claim 8, wherein the image information contains attribute information indicative of an attribute of the image information and wherein the output allowance determination section determines whether or not the output of the image information is allowed based on the attribute information.

14. The image processing apparatus according to claim 13, wherein the output allowance determination section converts the attribute information contained in the image information to another attribute information when the output of the image information is determined as being not allowed based on the attribute information.

15. The image processing apparatus according to claim 13, wherein the attribute information includes information regarding capability for monochrome printing and multicolor printing.
